(19) United States
(12) Patent Application Publication
(10) Pub. No.: US 2003/0009319 A1
(43) Pub. Date: Jan. 9, 2003

(54) Medium recorded with program for managing and utilizing information of plurality of corporations in real time, organization activity management method, and information processing system

(75) Inventors: Hiroyasu Fujiwara, Kawasaki (JP); Masaki Iwasada, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/015,660

(22) Filed: Dec. 17, 2001

(30) Foreign Application Priority Data
Jul. 5, 2001 (JP) 2001-204724

(51) Int. Cl. G06F 9/45

(52) U.S. Cl. 703/22

(57) ABSTRACT

An organization activity management method of managing data generated by a plurality of organizations on the basis of communication data transferred and received between the organizations, comprises inputting the communication data sent from a first organization to a second organization (S11, S31), simulating a first intra-organization procedure executed in the first organization when sending the communication data (S12 to S15, and S32 to S36), and recording first data generated by the first intra-organization procedure (S12 to S15, and S32 to S36).

### BACKGROUND OF THE INVENTION

The present invention relates to a technology of processing information related to a plurality of organizations.

Various categories of information are nowadays exchanged between corporations or between divisions in the corporation. Then, each corporation or division performs the business activities on the basis of the information obtained from other corporations or other divisions and the information generated by itself.

There is demanded a technology of grasping a state of business progress, for example, a state of how much a stage of issuing and receiving an order is progressed between the corporations. For instance, a sales company receives an order of a commercial article from a customer and notifies a maker of this order. The maker indicates a factory to produce this article. The factory requests a physical distributor to deliver this article. There is required the technology of grasping and managing the state of how much the order is progressed through the activities of the respective organizations.

A large-scale organization has hitherto prepared an information system in every division and individually managed the information. It is therefore difficult to grasp a state at the present time through the plurality of organizations as a whole in the case of issuing the order and shipping between the divisions.

Namely, the information held by the respective organizations are collected batchwise on the basis of a predetermined time, and hence the information of the respective organizations is hard to be managed side by side in real time.

Further, there is a case where pieces of information held individually be the respective organizations are not matched with each other. For example, a product price retained in the sales company might be different from a product price retained in the maker.

Therefore, it is difficult to precisely grasp the information related to the business at a specified point of time across the organizations. Further, in such a case, there might occur such a phenomenon that the information recognized correct in a certain organization proves incorrect in other organizations.

### SUMMARY OF THE INVENTION

It is a primary object of the present invention, which was devised to obviate the problems inherent in the prior art, to provide a technology capable of accurately managing information related to a plurality of organizations.

To accomplish the above object, according to one aspect of the present invention, an organization activity management method of managing data generated by a plurality of organizations on the basis of communication data transferred and received between the organizations, comprises inputting the communication data sent from a first organization to a second organization (S11, S31), simulating a first intra-organization procedure executed in the first organization when sending the communication data (S12 to S15, S32 to S36), and recording first data generated by the first intra-organization procedure (S12 to S15, S32 to s36).

The organization activity management method may further comprise detecting reply data to the communication data sent to the first organization from the second organization (S21, S41), simulating a second intra-organization procedure executed in the second organization when sending the communication data (S22 to S25, S42 to S46), and recording second data generated by the second intra-organization procedure (S22 to S25, S42 to S46).

Thus, according to the present organization activity management method, the first intra-organization procedure is simulated by use of the communication data sent to the second organization from the first organization. Further, the second intra-organization procedure is simulated by use of the communication data sent to the second organization from the first organization and the reply data to the communication data sent to the first organization from the second organization.

Further, according to the present invention, the second intra-organization procedure may be simulated irrespective of the step simulating the first intra-organization procedure.

According to another aspect of the present invention, an organization activity management method of managing data generated by a plurality of organizations on the basis of communication data transferred and received between the organizations, comprises inputting the communication data sent from a first organization to a second organization (S11, S31), detecting reply data to the communication data sent to the first organization from the second organization (S21, S41), simulating an intra-organization procedure executed in the second organization when sending the communication data (S22 to S25, S42 to S46), and recording data generated by the intra-organization procedure (S22 to S25, S42 to S46).

The organization activity management method may further comprise comparing the first data with second data (S11), and difference data between the organizations may be detected.

The organization activity management method may further comprise coupling the first data and the second data together (S1), and the procedures executed between the organizations may be tracked.

The organization activity management method described above may be executed as processing steps on the computer.

According to a further aspect of the present invention, an information processing system (5) for managing data generated by a plurality of organizations on the basis of communication data transferred and received between the organizations, comprises a module inputting the communication data sent from a first organization to a second organization, a module simulating a first intra-organization procedure executed in the first organization when sending the communication data, and a module recording first data generated by the first intra-organization procedure. Preferably, the respective modules described above may be made to function as processes on the computer.

According to a still further aspect of the present invention, there is provided a program read by a computer to actualize any one of the functions described above.

According o a yet further aspect of the present invention, there is provided a readable-by-computer recording medium recorded with such a program.

As explained above, according to the present invention, the intra-organization procedure is simulated based on the data transferred and received between the organizations, and it is therefore possible to accurately manage the data related to the plurality of organizations.

### BRIEF DESCRIPTION OF THE DRAWINGS

FIG. 1 is a diagram showing a concept of order tracking;

FIG. 2 is a diagram showing a problem of a difference management in a conventional supply chain management;

FIG. 3 is a diagram showing a system architecture of an information system in this embodiment;

FIG. 4 is a diagram showing a correlation between order issuing/receiving and shipping operations;

FIG. 5 is a diagram showing an outline of an internal process by a restoration processing system 5;

FIG. 6 is a diagram showing an operation image of the order tracking in an information system in one embodiment of the present invention;

FIG. 7 is a diagram showing an example of a data format setting screen for the tracking data;

FIG. 8 is a diagram showing an example of a screen for the order tracking;

FIG. 9 is an explanatory diagram showing a difference management function in the present information system;

FIG. 10 is a diagram showing an example of a difference management function in the information system in one embodiment of the present invention;

FIG. 11 is a diagram showing an example of a data format setting screen for data that indicate price differences;

FIG. 12 is a diagram showing an example of a data structure of ordering data;

FIG. 13 is a diagram showing an example of a data structure of a master database;

FIG. 14 is a diagram showing an example of a data structure of an remaining order database;

FIG. 15 is a diagram showing an example of a data structure of a receipt result database;

FIG. 16 is a diagram showing an example of a data structure of a back order database;

FIG. 17 is a diagram showing an example of a data structure of an invoice database;

FIG. 18 is a diagram showing an example of a data structure of an inventory database;

FIG. 19 is a diagram showing an example of a data structure of an in-transit database;

FIG. 20 is a flowchart showing a processing flow of an ordering restoration process and a processing flow of an order receiving restoration process; and

FIG. 21 is a flowchart showing a processing flow of a shipping restoration process and a processing flow of a receipt restoration process.

### DETAILED DESCRIPTION OF THE PREFERRED EMBODIMENT

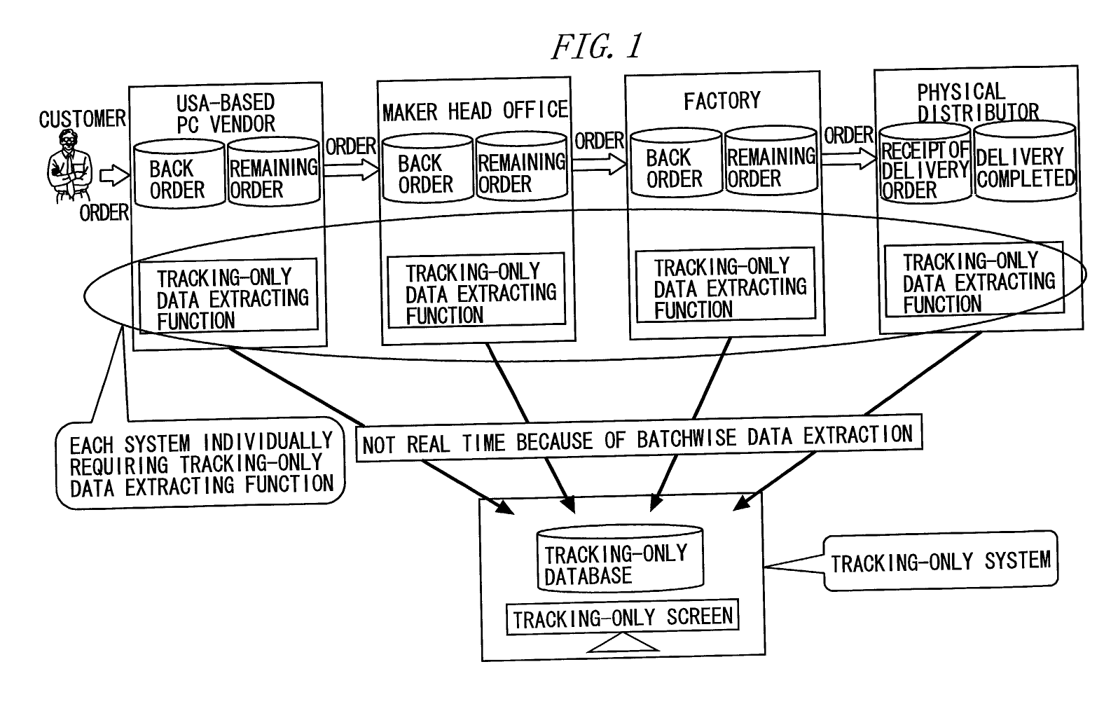

An embodiment of the present invention will hereinafter be described with reference to FIGS. 1 through 21.

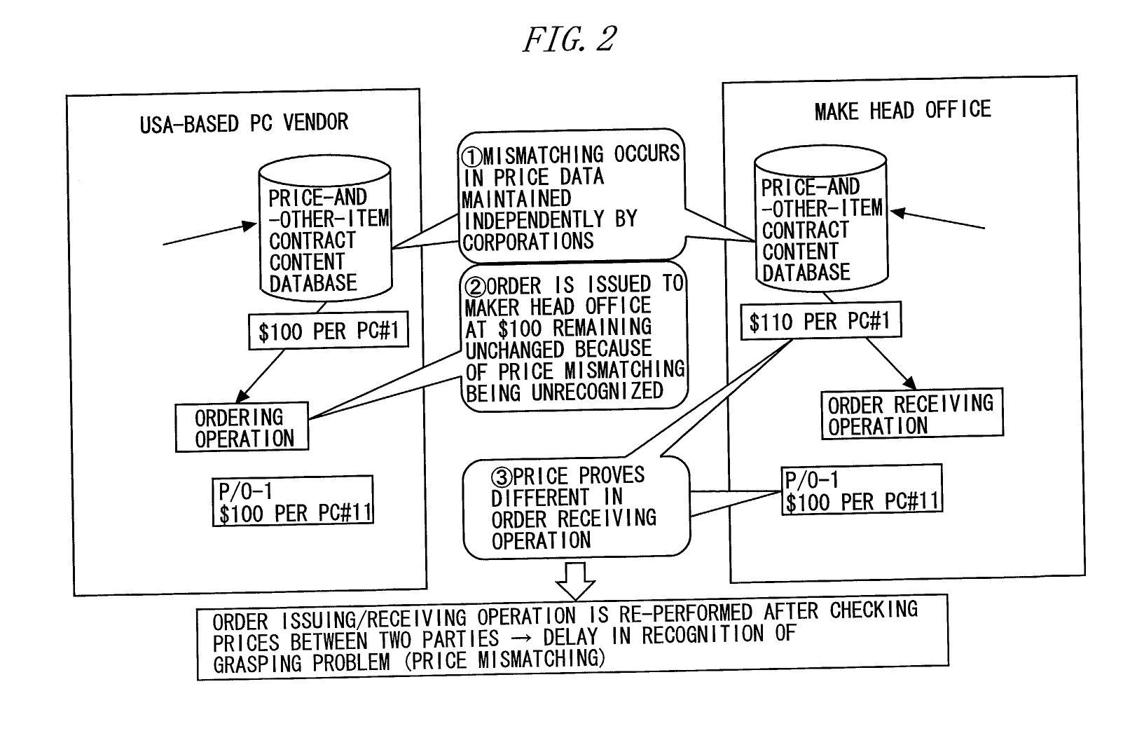

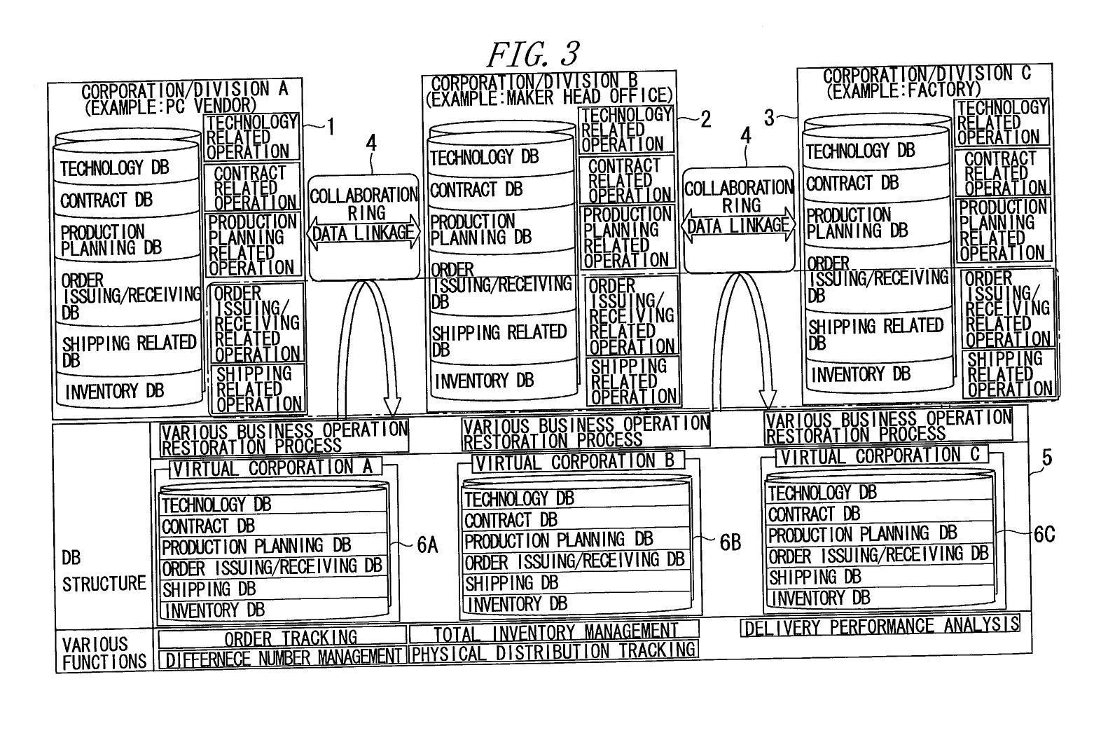

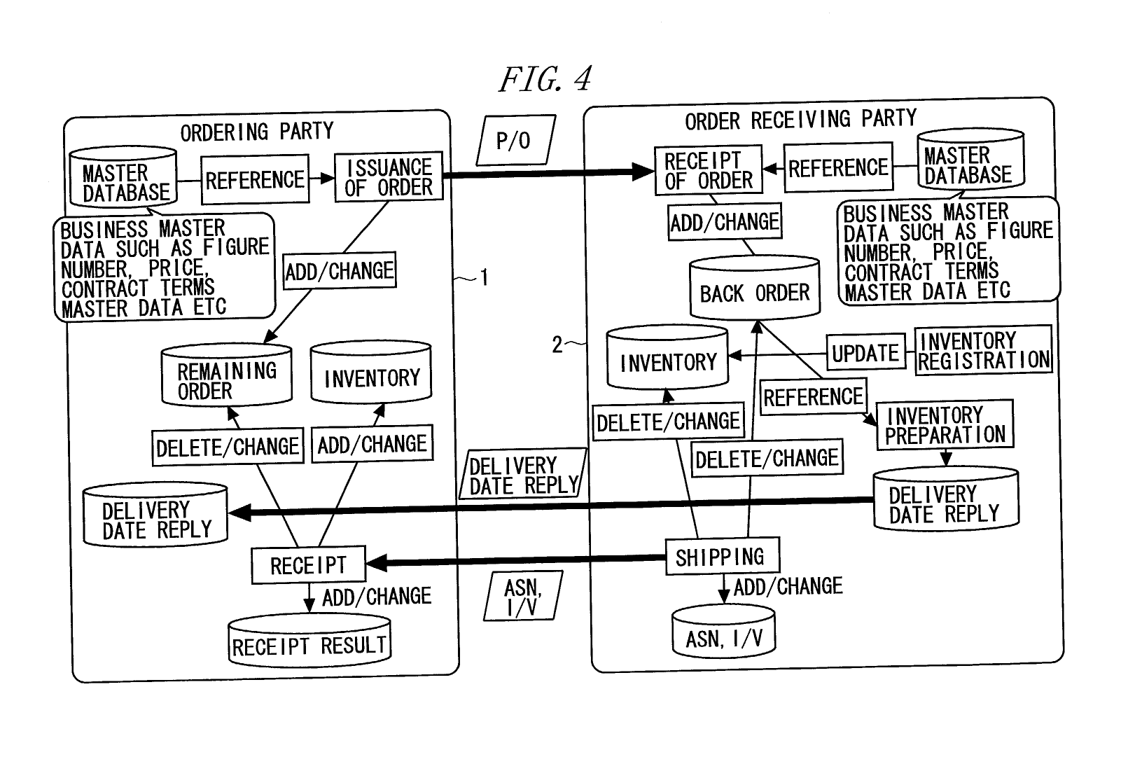

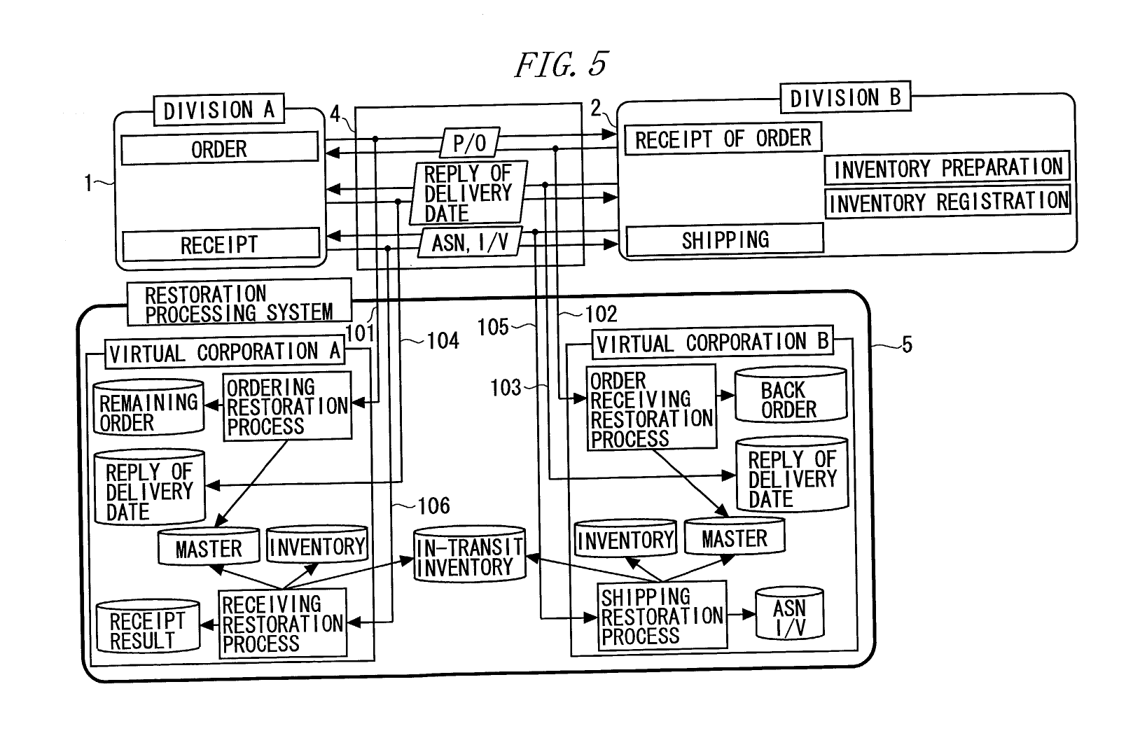

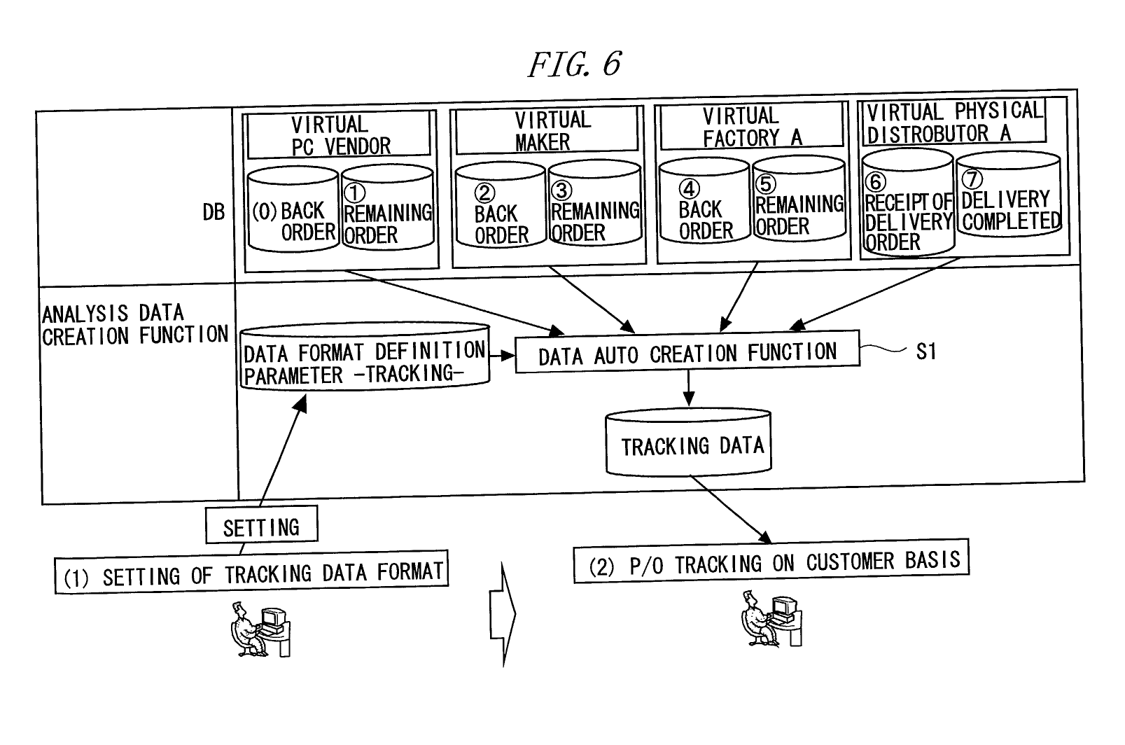

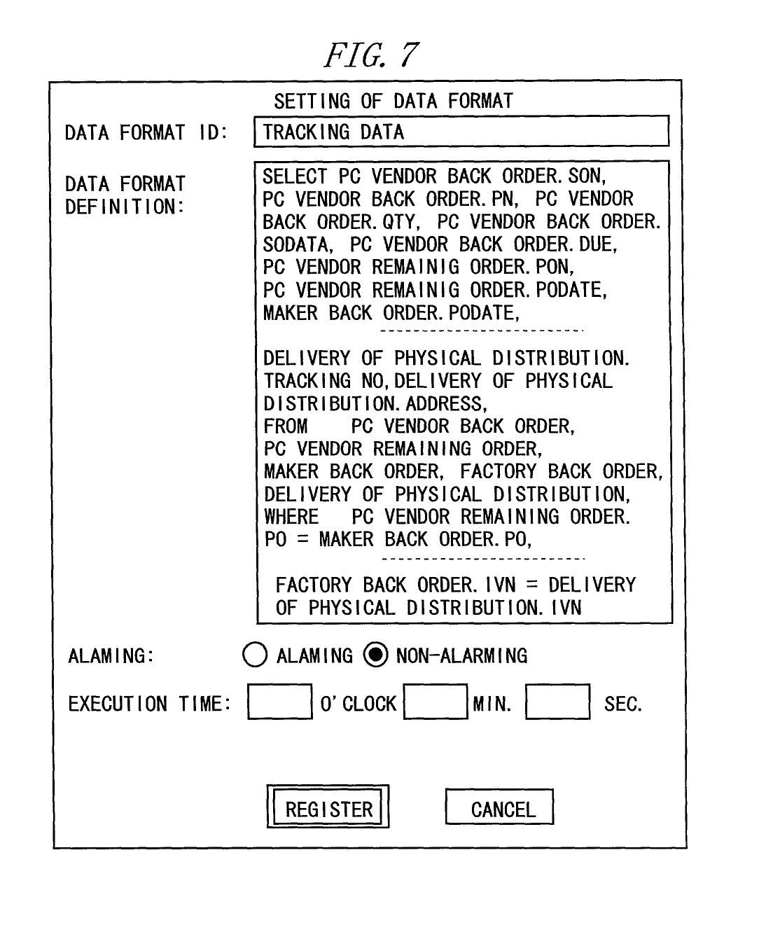

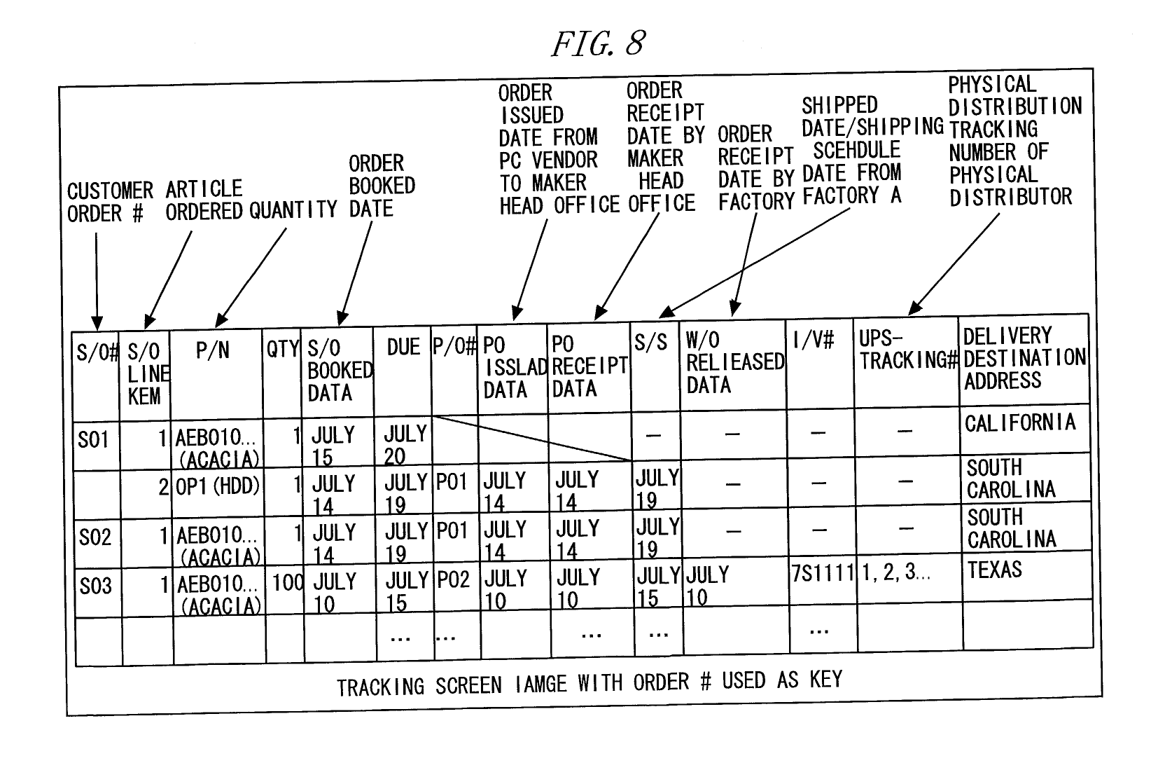

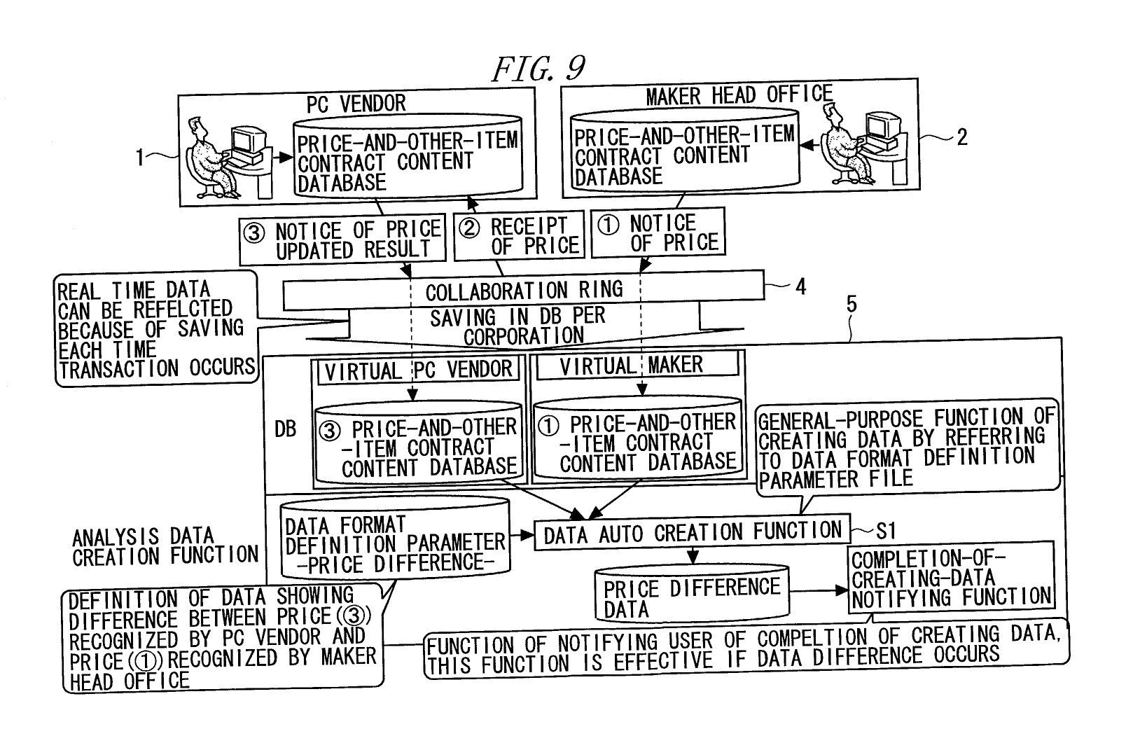

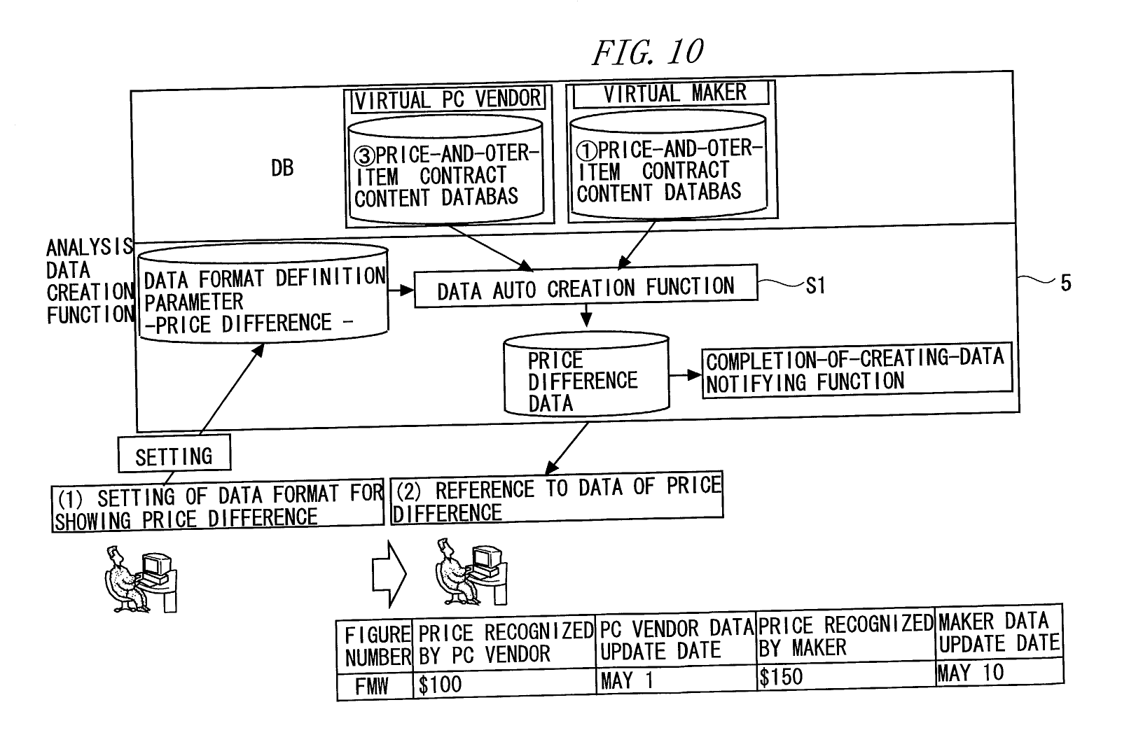

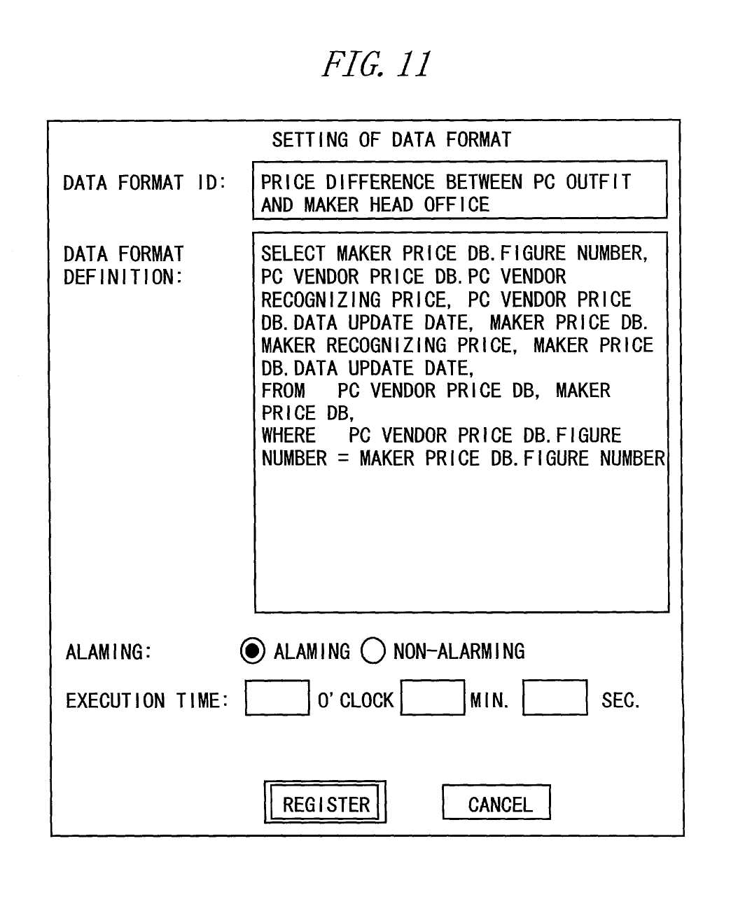

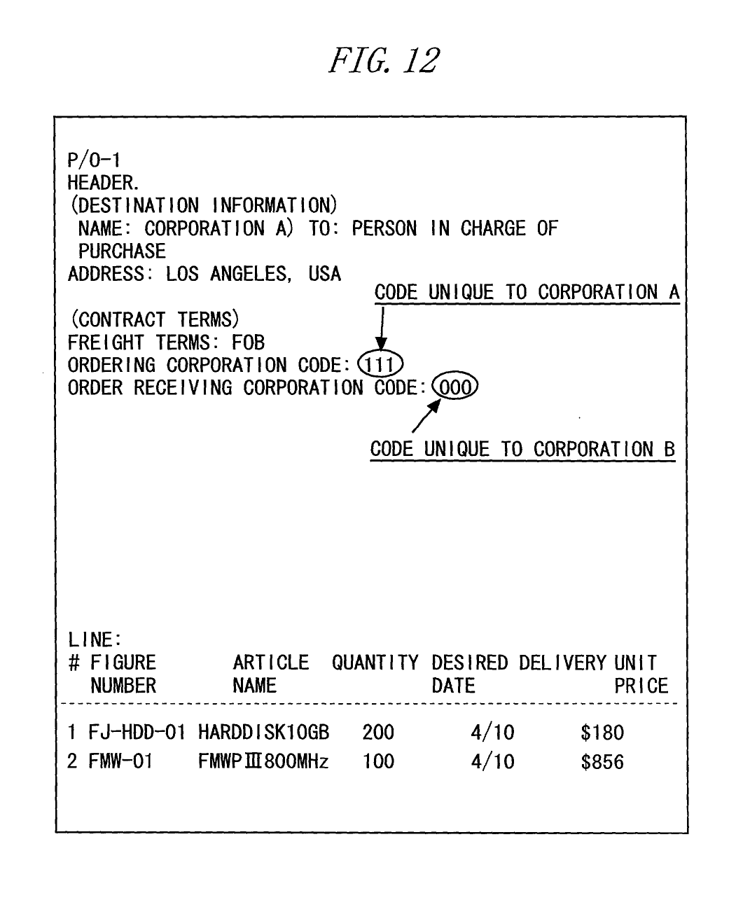

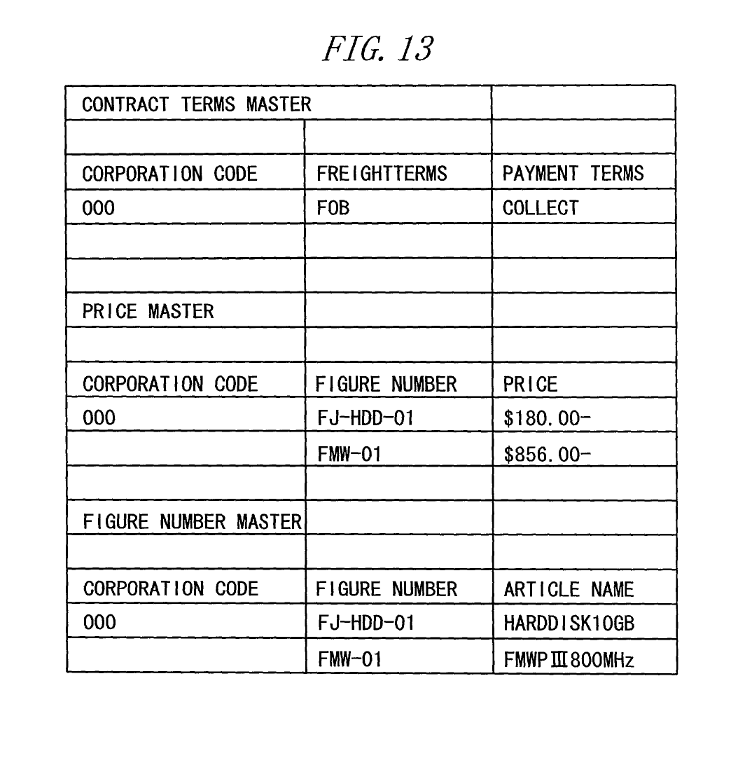

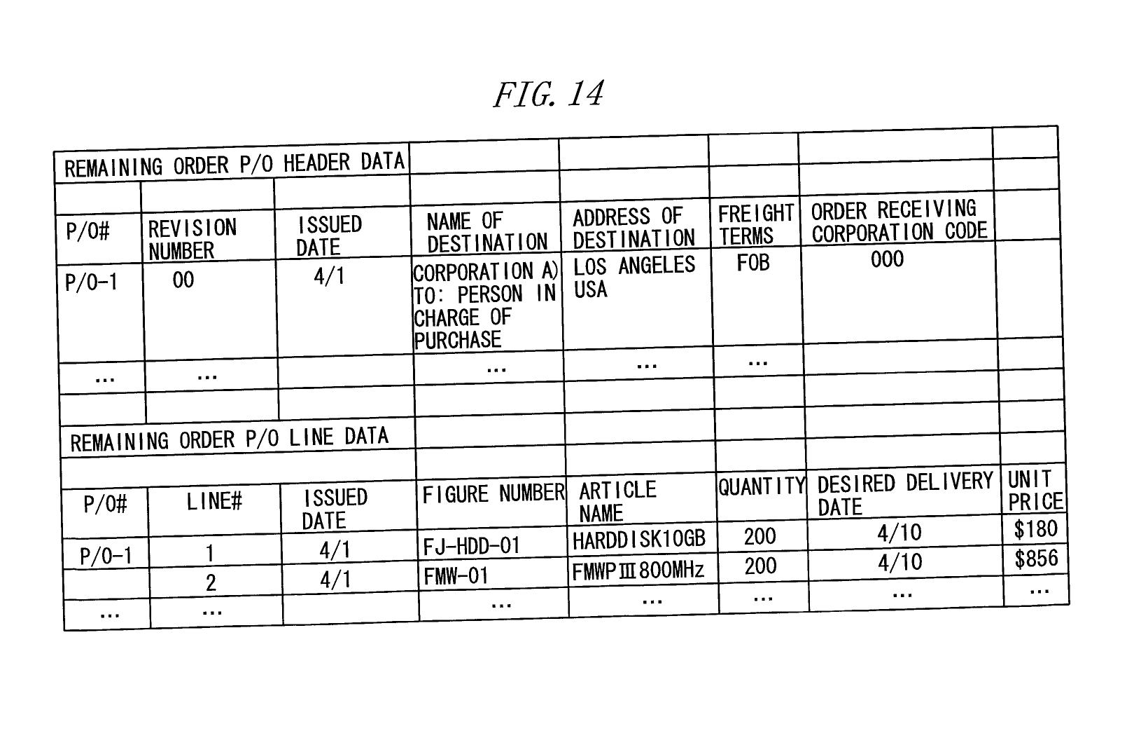

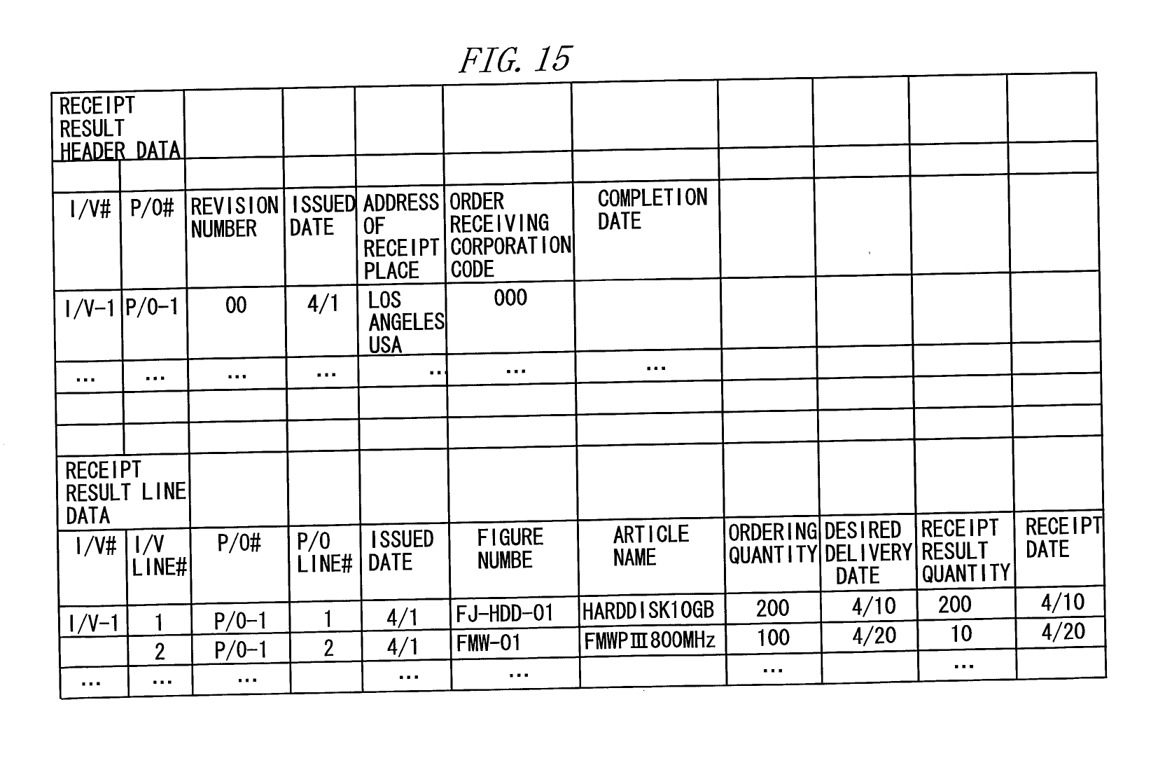

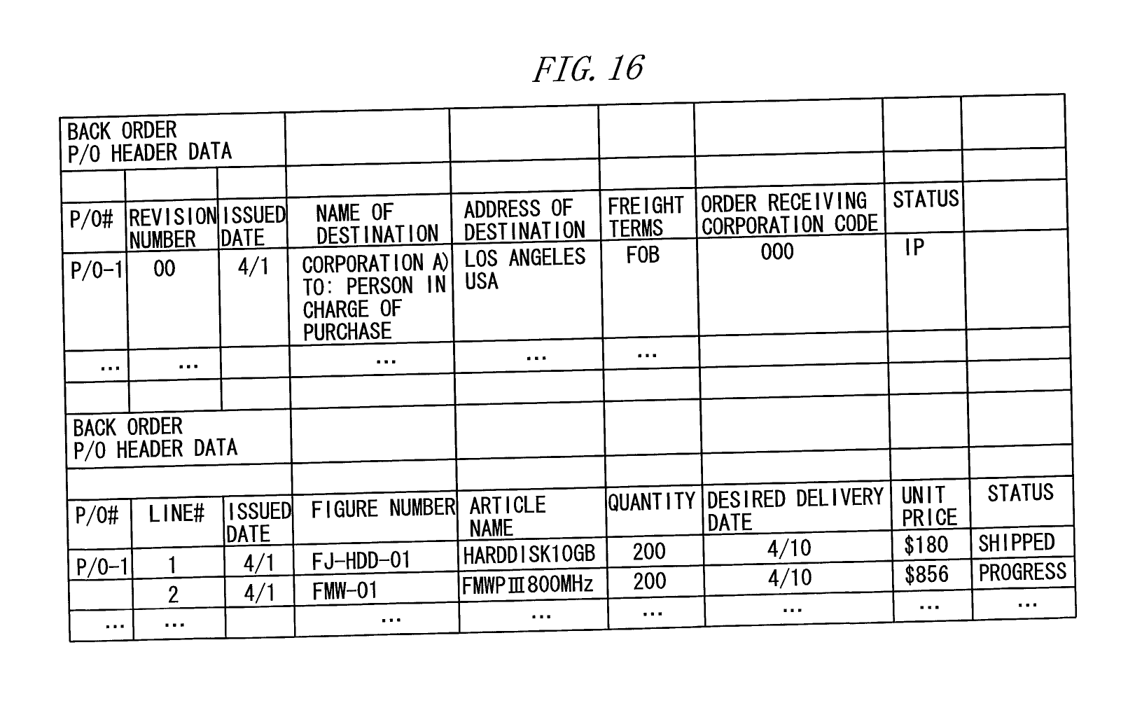

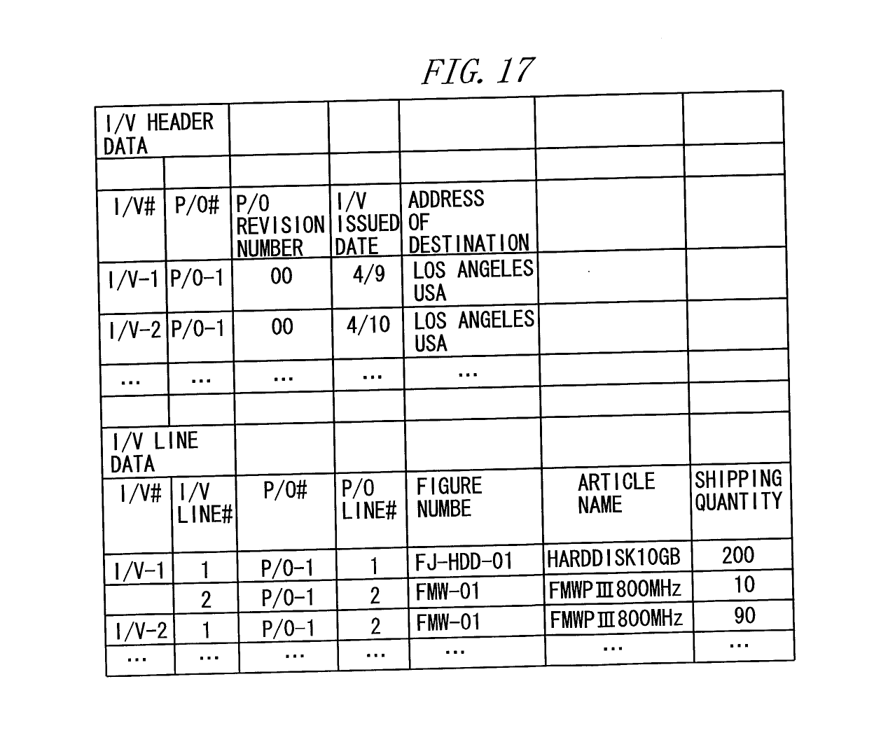

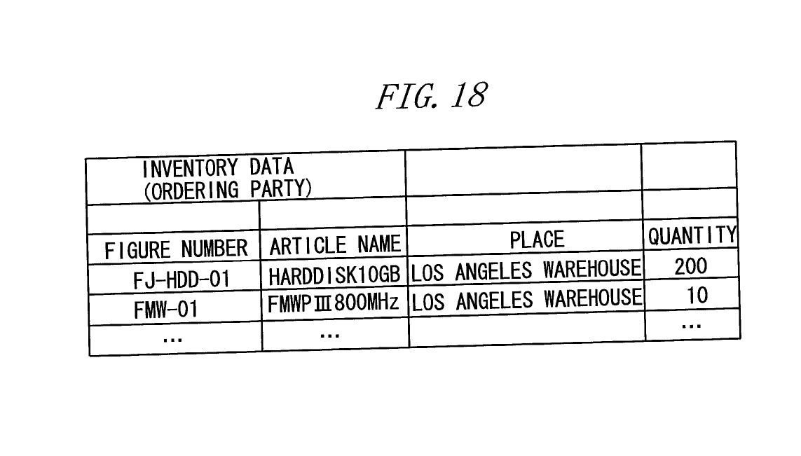

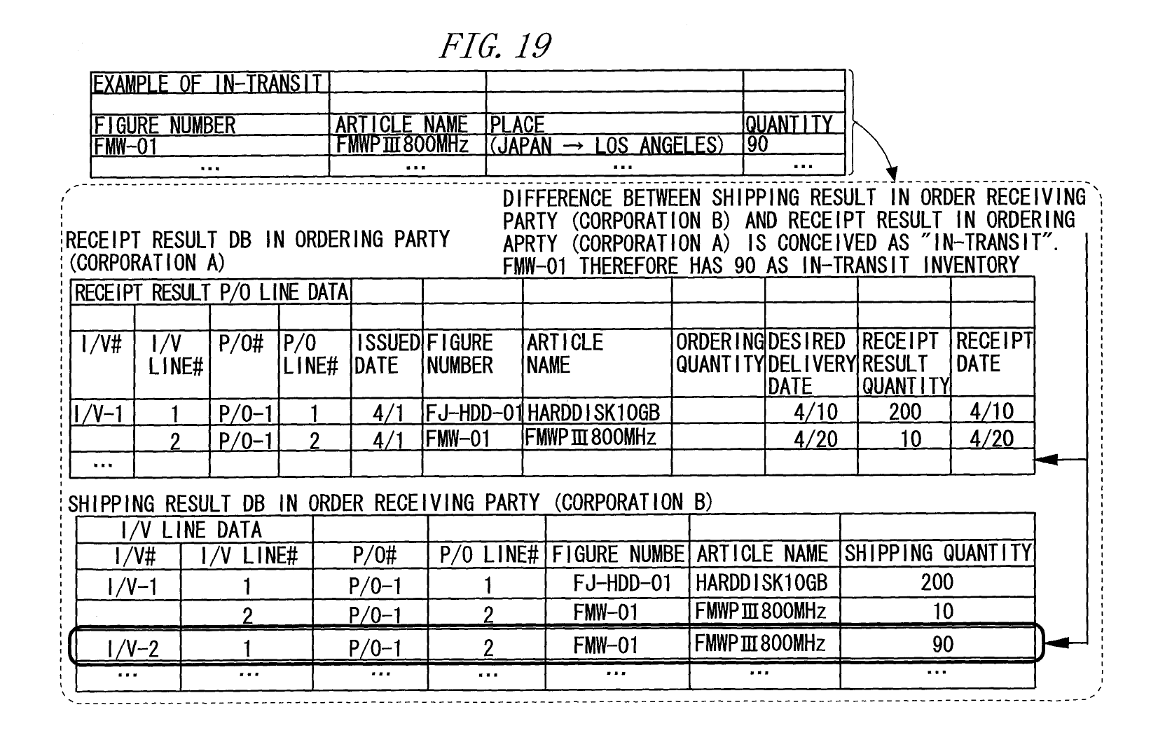

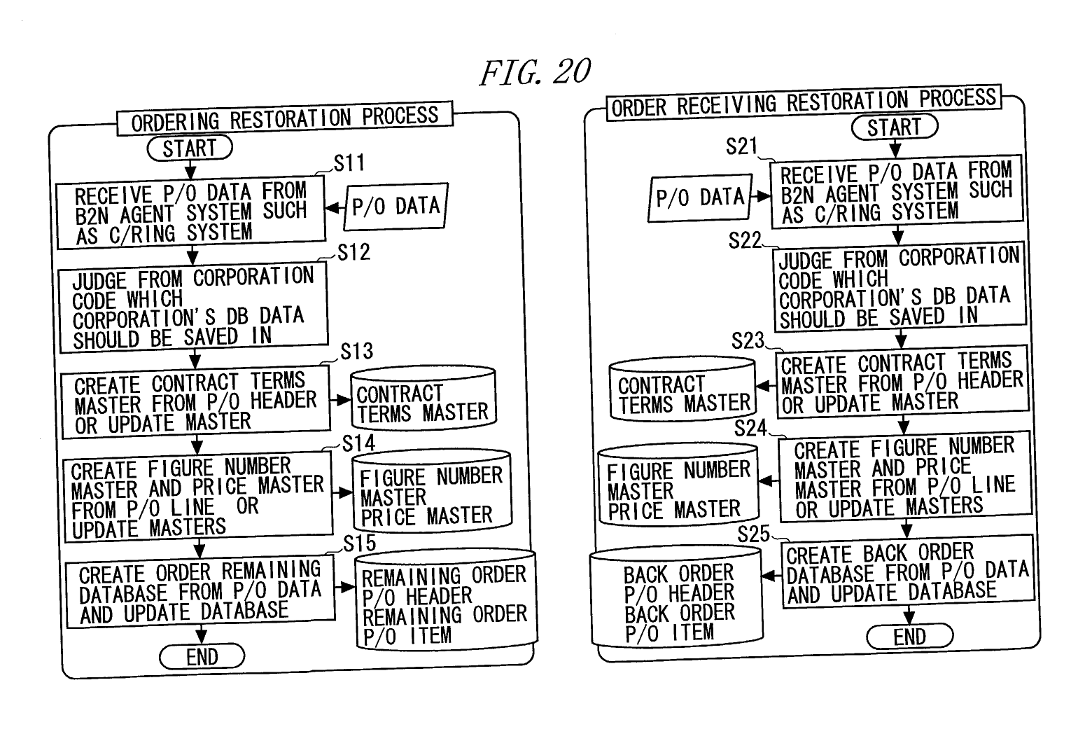

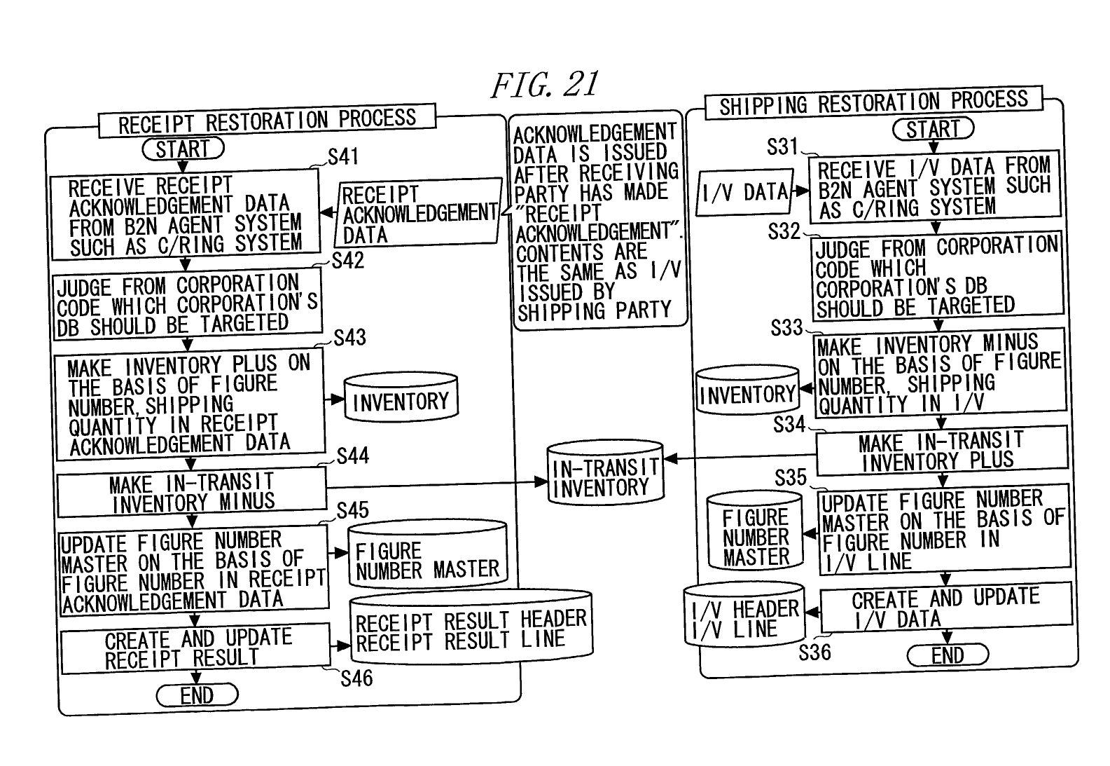

FIG. 1 is a diagram showing a concept of order tracking in a supply chain management (that will hereinafter be abbreviated to SCM). FIG. 2 is a diagram showing a problem of a difference management in the conventional SCM. FIG. 3 is a diagram showing a system architecture of an information system in this embodiment. FIG. 4 is a diagram showing a correlation between order issuing/receiving and shipping operations in the present information system. FIG. 5 is a diagram showing an outline of an internal process by a restoration processing system 5 illustrated in FIG. 3. FIG. 6 is a diagram showing an operation image of the order tracking in the present information system. FIG. 7 is a diagram showing an example of a data format setting screen for the tracking data shown in FIG. 6. FIG. 8 is a diagram showing an example of a screen displaying the order tracking in the present information system. FIG. 9 is an explanatory diagram showing a difference management function in the present information system. FIG. 10 is a diagram showing an example of the difference management operation in the present information system. FIG. 11 is a diagram showing an example of a data format setting screen for data that indicate price differences. FIG. 12 is a diagram showing an example of a data structure of ordering data. FIG. 13 is a diagram showing an example of a data structure of a master database. FIG. 14 is a diagram showing an example of a data structure of an remaining order database. FIG. 15 is a diagram showing an example of a data structure of a receipt result database. FIG. 16 is a diagram showing an example of a data structure of a back order database. FIG. 17 is a diagram showing an example of a data structure of an invoice database. FIG. 18 is a diagram showing an example of a data structure of an inventory database. FIG. 19 is a diagram showing an example of a data structure of an in-transit database. FIG. 20 shows a processing flow of an ordering restoration process and a processing flow of an order receiving restoration process. FIG. 21 shows a shipping restoration process and a receipt restoration process.

<Problem of Conventional Supply Chain Management>

FIG. 1 shows the concept of the order tracking defined as one function of the SCM. The order tracking is a function capable of tracking, for example, an order state and a delivery state of a business target article.

Referring to FIG. 1, an assumption is that a customer orders a personal computer (that will hereinafter be abbreviated PC) via a USA-based personal sales corporation (that will be hereinafter be simply called to a PC vendor). This order is sent to a head office of the maker from the USA-based PC vendor and further sent to a factory. The factory indicates a physical distributor to deliver the PC ordered. The order tracking is the function of grasping the present order state from a flow of information based on the article order described above.

According to the conventional system, an individual information system of every organization, e.g., each of the USA-based PC vendor, the maker head office, the factory and the physical distributor, executed the order tracking described above. Therefore, each information system individually needs a data extracting function for the tracking.

Further, such a tracking-only data extracting function is executed batchwise at a predetermined timing. A user was able to confirm tracked pieces of information on a tracking-only screen. It was, however, difficult to confirm the as-of-now information in real time. There arose a problem for the reason elucidated above, wherein the conventional system is incapable of eliminating an influence by a difference data in the business information between corporations or divisions.

FIG. 2 shows the problem of a difference management in the conventional SCM. FIG. 2 also shows a detailed business operation flow between the USA-based PC vendor and the maker head office illustrated in FIG. 1.

It is now assumed that a prices of a specified product (PC#1 in FIG. 2) is revised. A timing of such a revision of the price is not necessarily coincident in the information system where in each organization individually performs the business operation.

Accordingly, there might be a case where mismatching occurs in the price information maintained independently by each organization. To be more specific, referring to FIG. 2, the USA-based PC vendor sets a product price of PC#1 at 100 dollars, and nevertheless the same PC#1 is priced at 110 dollars in the maker head office.

Even when this kind of price mismatching occurs, this mismatching is not detected if the information system is individually operated in each organization. Accordingly, the USA-based PC vendor orders the PC#1 priced at 100 dollars.

Then, such a price difference is not recognized till it comes to a stage of receiving the order at the maker head office. Hence, it is needed to confirm the price between the USA-based PC vendor and the maker head office. Further, the order issuing/receiving operation is to be restarted. As described above, the conventional system tends to delay grasping the difference data, e.g., the mismatching in price.

<System Architecture>

FIG. 3 shows the system architecture of the information system in this embodiment.

This information system is configured by computers 1 to 3 installed in respective divisions of a corporation, collaboration rings 4 for connecting these computers, and a restoration processing system 5 for restoring various categories of business operations in every division on the basis of information provided from the collaboration rings 4.

As shown in FIG. 3, each of divisions A through C in the corporation performs the various categories of business operations. These business operations are, for example, a technology related business operation, a contract related business operation, a production planning related business operation, an order issuing/receiving related business operation and a shipping related business operation.

Further, various categories of data generated with the implementations of these business operations are accumulated in databases managed by the intra-division computers 1 through 3. These categories of data are, for instance, technology related data (shown as technology DB), contract related data(shown as contract DB), production planning related data (shown as production planning DB), order issuing/receiving related data(shown as order issuing/receiving DB), shipping related data(shown as shipping DB) or inventory data(shown as inventory DB).

The order issuing/receiving and shipping related business operations among those operations are executed by collaborations among the divisions. Therefore, the order issuing/receiving and shipping related data related to these business operations are transferred and received between the divisions 1 through 3 via the collaboration rings 4. The collaboration rings 4 provide data transmitting functions between the intra-division computers 1 through 3, and provide these categories of data to the restoration processing system 5.

The restoration processing system 5, based on the data provided from the collaboration rings 4, makes on-the-computer restorations of the various categories of business operations in the divisions A to C. Herein, the “restoration” interminology implies that the processes of generating, updating and deleting the information (data) based on the actual business activities are executed in simulation on the computer.

The restoration processing system 5 generates virtual corporations A to C (that correspond to the divisions A to C) and visualizes the respective business activities. Namely, the restoration processing system 5, based on the data flowing across the collaboration rings 4, generates various categories of data generated within the virtual corporations A to C. The various categories of data generated by the restoration processing system 5 are based on the processes restored in the virtual corporations A to C and might be different from the real data in the divisions A to C of the corporations in reality.

The data based on this business operation restoring process are, however, generated based on the information (data) flowing interfaces between the divisions. For instance, inside data 6A and inside data 6B of the divisions A and B are generated based on the order data transmitted from the division A to the division B in the corporation. Accordingly, these items of inside data 6A etc are, it may be said, generated based on the information clarified (released) to the outside by the respective divisions in the corporation, and may also indicate the states in which those divisions should essentially be.

The restoration processing system 5, based on the virtual inside data 6A to 6C indicating the states in which those divisions should essentially be, provides functions such as the order tracking, the inventory management of overall corporate groups, delivery performance analyses, the difference management or physical distribution tracking.

The collaboration rings 4 are computers for connecting the intra-division computers 1 to 3. The collaboration rings 4 function to transmit the data between the divisions and transfer the same information to the restoration processing system 5. Note that the present applicant had already proposed the architectures of the collaboration rings 4 in Japanese Patent Application Nos.2000-163649, 2001-139572, 2000-148956 and 2001-139573.

The intra-division computers 1 to 3, the collaboration rings 4 and the restoration processing system 5 shown in FIG. 3 are typical computers each including a CPU, a memory, a hard disk, a communication interface and so on. The architecture and operations thereof are broadly known, and hence their explanations are herein omitted.

<Outline of Functions>

FIG. 4 shows the correlation of the order issuing/receiving and shipping operations between the divisions. When dealing with, e.g., the ordering operation, the ordering side computer 1 refers to the master database and reads the business master data such as a figure number, a price, contract terms etc of an ordering target article. The ordering side computer 1, based on these items of master data, generate the order data (indicated by P/O in FIG. 4) and transmits the P/O to the order receiving side computer 2 via the collaboration ring 4. At this time, the ordering side computer 1 adds an additional change to the remaining order database.

On the other hand, the order receiving side computer 2 that receives the order data collates the order data with the master data, and adds an additional change to the back order database. Further, the order receiving side computer 2, to which a result of manufacturing the article is inputted, updates the inventory data. Further, the order receiving side computer 2 refers to the back order database, then executes an inventory preparation process, and transmits a reply about a delivery date of an ordered article to the ordering side computer 1.

Moreover, the order receiving side computer 2, to which article shipping data is inputted, updates each of the back order database and the inventory database on the basis of the article shipping data. Further, the order receiving side computer 2 creates an advanced shipping notice (which is abbreviated to ASN in FIG. 4) and an invoice (which is described as I/V in FIG. 4), and records the ASN and I/V in the database.

The invoice etc is transmitted to the ordering side computer 1 upon shipping the article. The ordering side computer 1, upon receiving the invoice and an article receipt completion notice, executes an article receiving process. Namely, the ordering side computer 1, based on the invoice, adds a receipt count to the receipt result database and to the inventory database, and updates a remaining count in the remaining order database.

FIG. 5 shows the outline of the internal process by the restoration processing system with respect to the order issuing/receiving and shipping operations. In this internal process, the restoration processing system 5 restores the processes in the virtual corporations on the basis of the data obtained from the collaboration rings 4.

As shown in FIG. 5, the restoration processing system 5 executes an ordering restoration process, an order receipt restoration process, a shipping restoration process or a receipt restoration process that simulate the business procedures conducted by the real divisions A, B and so on in the virtual corporation A or B.

Further, the restoration processing system 5 stores the respective database with the various categories of data generated as a result of executing the above processes, such as the remaining order data, the back order data (it may be called backlog data or remaining of received order data which is the data of ordering information accepted to an receiving side and the shipping of which is not completed), the delivery date reply data, the inventory data, the advanced shipping notice (ASN), the invoice (I/V) and the receipt result data.

For example, when the division A sends the order to the division B, an ordering process in the computer 1 in the division A functions to transmit the order data (P/O) to the collaboration ring 4.

The collaboration ring 4 transmits the order data addressed to the division B to the computer 2 in the division B, and transfers the same order data to the restoration processing system 5 (as indicated by an arrowhead 101).

An order receipt process executed by the computer 2 in the corporation B functions to update the data in the computer 2 on the basis of the received order data, and to send an order receipt notice that the order is formally received back to the collaboration ring 4.

The collaboration ring 4 sends to the computer 1 the order receipt notice addressed to the division A, and transfers the same notice to the restoration processing system 5 (as indicated by an arrowhead 102).

The restoration processing system 5, when obtaining the order data forwarded to the division B from the division A, executes the ordering restoration process simulating the ordering process within the virtual corporation A. In this ordering restoration process, the restoration processing system 5 refers to the master database in the virtual corporation A, and updates the remaining order data. Further, the restoration processing system 5 updates the master database in the virtual corporation A as the necessity may arise.

Moreover, the restoration processing system 5, when obtaining the order receipt notice forwarded to the corporation A from the corporation B, executes the order receipt restoration process simulating the order receipt process within the virtual corporation B. In this order receipt restoration process, the restoration processing system 5 refers to the master database in the virtual corporation B, and updates the back order data. Further, the restoration processing system 5 updates the master database in the virtual corporation B as the necessity may arise.

Next, for example, the computer 2 in the division B transmits a delivery date reply addressed to the corporation A to the collaboration ring 4. The collaboration ring 4 transmits this delivery date rely to the computer 1 in the corporation A, and transfers the same reply to the restoration processing system 5 (as indicated by an arrowhead 103).

The ordering process in the computer 1, upon receiving the delivery date reply, functions to send an acknowledgment notice that the delivery date reply is received back to the collaboration ring 4.

The collaboration ring 4 transmits this acknowledgement notice to the computer 2 in the corporation B, and transfers the same notice to the restoration processing system 5 (as indicated by an arrowhead 104).

The restoration processing system 5, when obtaining the delivery date reply forwarded to the corporation A from the corporation B, updates the delivery date reply database in the virtual corporation B. Further, the restoration processing system 5, when obtaining the acknowledgement notice forwarded to the corporation B from the corporation A, updates the delivery date reply database in the virtual corporation A.

Next, for instance, the division B transmits, upon shipping the product to the division A, the ASN and I/V to the collaboration ring 4.

The collaboration ring 4 sends the ASN and the I/V to the computer 1 in the division A and transfers the ASN and I/V to the restoration processing system 5 (as indicated by an arrowhead 105).

The restoration processing system 5, when obtaining the advanced shipping notice (ASN) and the invoice (I/V) forwarded to the division A from the division B, executes the shipping restoration process simulating the shipping process in the virtual corporation B. In this shipping restoration process, the restoration processing system 5 records the ASN and I/V in the database.

Further, the restoration processing system 5 refers to the master database in the virtual corporation B, and updates the inventory data and the back order data. Further, the restoration processing system 5 updates the master database in the virtual corporation B as the necessity may arise.

Next, for example, when the division A receives the product from the division B, the computer 1 transmits a receipt completion notice to the collaboration ring 4.

The collaboration ring 4 sends the receipt completion notice to the computer 2 in the division B and transfers this notice to the restoration processing system 5 (as indicated by an arrowhead 106).

The restoration processing system 5, when obtaining the receipt completion notice forwarded to the division B from the division A, executes the receipt restoration process simulating the receipt process in the virtual corporation A. In this receipt restoration process, the restoration processing system 5 records the receipt result data.

Further, the restoration processing system 5 refers to the master database in the virtual corporation A, and updates the inventory data and the remaining order data. Further, the restoration processing system 5 updates the master database in the virtual corporation A according to the necessity.

<Order Tracking>

FIG. 6 shows the operation image of the order tracking based on the various categories of data generated by the restoration processing system 5. With the variety of restoration processes executed, for example, the back order data and the remaining order data are generated on the database provided, for every division, in the restoration processing system 5.

A search specifying an order number (order #) into the database provided for every division in the restoration processing system 5, is defined as an order tracking function. In this case, to start with, the user sets, as data format definition parameters, a search procedure and a data format of the data extracted from the database in the restoration processing system 5. An SQL (Structured Query Language) used for, e.g., a relational database is used as this data format definition parameter.

As shown in FIG. 6, the data format definition parameter is transferred to a data auto creation function (S1). The data auto creation function (S1) commands an unillustrated database management system to execute searching for the data with this parameter used as a key, thereby extracting the tracking data.

With this process executed, for example, according to the order number, a parts number and a order date of the ordered article are extracted from the remaining order database of the virtual PC vendor, a maker order receipt date (booked date) is extracted from the back order database of the virtual maker, a factory shipping date is extracted from the shipping database of the virtual factory A, and a tracking number of the physical distributor is extracted from the delivery order receipt database. The thus extracted data are stored as the tracking data.

Further, there may be a case where the user desires to execute the order tracking, for instance, on a specified customer basis. This may involve setting the SQL for extracting data on the customer basis from the tracking data generated in the way described above. The database operation using the SQL is exemplified in, e.g., FIG. 7.16 in Chapter 2.4 of [Information Processing Handbook], Vol. 7, the First Edition, issued on May 30, 1989, compiled by Information Processing Society of Japan.

FIG. 7 shows the example of the screen for setting the tracking data format on the terminal connected to the restoration processing system 5. The user specifies a format of the data extracting from the database of the restoration processing system 5 and a method for extracting the data by use of the SQL.

This data format setting screen contains, from upper to lower on the screen, a data format ID box, a data format definition box, an alarm specifying checkbox, an execution time specifying box, a “register” button and a “cancel” button.

An ID for identifying an SQL parameter to be defined is specified (entered) in the data format ID box.

A format of the tracking data to be generated and a method of extracting the tracking data from the database, are specified in the data format definition box.

The alarm specifying checkbox is checked to specify whether to deliver an alarm e-mail to the user when data have been extracted.

A time when executing the data extraction process is specified in the execution time specifying box. Contents of the settings on this screen are registered as parameters by clicking the “register” button. Further, the contents of the settings are canceled by clicking the “cancel” button.

FIG. 8 shows the example of the tracking data extracted in the procedures described above. In this example, there are generated the tracking data consisting of a customer order #, a parts number of the ordered article, a quantity, an order receipt data (booked date), a deadline (Due), an order number (P/O#), a date (issued date) when the PC vendor issued the order to the maker, a receipt date when the maker received the order, a date when the factory received the order, a date when the factory shipped the article (or a shipping schedule date) and a tracking number of the physical distributor.

<Management of Difference Data>

FIG. 9 shows the concept of the difference management function. FIG. 9 clearly shows a procedure of transferring and receiving content data of a contract agreed upon between the maker head office and the PC vendor.

When establishing the contract for selling the article, for instance, the computer 2 in the maker head office sends a price notice addressed to the PC vendor to the collaboration ring 4. The collaboration ring 4 transmits the received price notice to the computer 1 in the PC vendor, and transfers the same notice to the restoration processing system 5.

With this notice received, the restoration processing system 5 updates a price-and-other-item contract content database (that may also be called a price master table in this embodiment) of the virtual maker.

On the other hand, the computer 1 of the PC vendor having received the price notice transmits a price updated result notice to the collaboration ring 4. The collaboration ring 4 sends this received price updated result notice to the computer 2 and transfers the same notice to the restoration processing system 5.

With this notice received, the restoration processing system 5 updates the price-and-other-item contract content database of the virtual PC vendor. The price-and-other-item contract content databases of the virtual maker and of the virtual PC vendor are restored in real time by use of the data thus transferred and received between the maker head office and the PC vendor, and stored in the database of the restoration processing system 5 in a way that sorts out these content databases corresponding to the divisions (corresponding to the virtual maker, the virtual PC vendor and so on).

SQLs for extracting a price retained in the virtual PC vendor and a price retained in the virtual maker are set in the database of the restoration processing system 5, and these pieces of data are extracted, whereby a difference management can be executed.

In this case, a start time of an execution of an SQL statement may be set at a predetermined time. The SQL statement is executed at the set time, and, if there is a difference between extracted pieces of difference data, the user may be informed of this difference by an e-mail.

FIG. 10 shows an example of an operation conducted when in such a difference management. Now, supposing that the user desires to know a price difference between the two divisions, for instance between the maker head office and the PC vendor, data format definition parameters (SQLs) used for executing a comparison between the price-and-other-item contract content database of the virtual maker and the price-and-other-item contract content database of the virtual PC vendor, are generated in the same way as shown in FIG. 7.

These parameters are SQLs for, if there is, for instance, a price difference between records with the same figure number that are extracted from the two databases, indicating this figure number the prices retained in these two databases and a data update date/time.

As shown in FIG. 10, the data format definition parameters are transferred to the data auto creation function (S1). The data auto creation function (S1) commands the unillustrated database management system to search the data with these parameters used as keys, thereby extracting the price difference data.

FIG. 11 shows an example of the SQL setting screen. It can be understood from FIG. 11 that pieces of data containing the coincident figure number and non-coincident prices are selected with these parameters used as the keys by comparing the database containing a PC vendor price with the database containing a maker price.

With respect to, e.g., an article having a figure number “FMW”, pieces of data that a PC vendor recognized price is 100 dollars, that a PC vendor data update date is May 1, that a maker recognized prices is 150 dollars and that a maker data update date is May 10, are thus detected (FIG. 10).

<Data Structure>

FIGS. 12 through 19 show examples of data structures of the data processed by the restoration processing system 5. FIG. 12 shows an example of the data structure of the order data (P/O). This item of order data consists of an order number (a character string “P/O-1” in FIG. 12), a header (Header) and line data (Line).

The order number is an identification character string unique to the order data. The header contains pieces of destination information and contract terms. These pieces of destination information thereof are a name of a person in charge and an address of the partner corporation. Further the contract terms include freight terms, an ordering corporation code, an order receiving corporation code and so on.

The “Line” field (line data) is recorded with pieces of data that specify an article to be ordered. This “Line” field contains items such as a line number, a figure number, a name of article, a quantity, a desired delivery date and a unit price. The figure number among these items is an identification code unique to the article. The “Line” filed (line data) contains a plurality of articles listed up in a way that identifies these articles with the figure numbers.

FIG. 13 shows an example of a master database in the virtual corporation as an ordering party. The master database retained by the restoration processing system 5 includes, for example, a contract terms master table, a price master table, a figure number master table and so on.

The contract terms master table is recorded with contract terms with a transaction party (an order receiving party). Each record in the contract terms master table consist of data entered in a “corporation code” field, a “freight terms” field and a “payment terms” field.

The price master table is recorded with an article price in each transaction party (the order receiving party). Each record in the price master table consists of a corporation code, a figure number and a price. The price master table, based on this data structure, retains a dealing price of the article indicated by the figure number for every transaction specified by the corporation code.

The figure number master table is recorded with the article for every transaction party (the order receiving party). The figure number master table contains a “corporation code” field, a “figure number” field and an “article name” field. The figure number master table is, based on this data structure, recorded with the figure number and the article name corresponding to this figure number with respect to every transaction party.

FIG. 14 shows an example of the data structure of the remaining order database. The remaining order database includes (table-formatted) header data and line data.

The header data in the remaining order database contains an order number (P/O#), an revision number, an issued date, a name of delivery destination, an address of delivery destination, freight terms and an order receiving corporation code. The order number among these items is an identification number unique to each record of remaining order data.

Further, the line data table of the remaining order database is recorded with the line data in the issued order data (FIG. 12). An order number is, however, added in order to identify each record of order data. Namely, the line data table of the remaining order database contains an “order number” field, a “line number (Line#)” field, an “issued date” field, a “figure number” field, an “article name” field, a “quantity” field, a “desired delivery date” field and a “unit price” field.

FIG. 15 shows an example of the data structure of the receipt result database. The receipt result database also includes a header data (receipt result header data) table and a line data (receipt result line data) table.

The receipt result header data table contains an “invoice number (I/V#)” field, an “order number (P/O#)” field, an “revision number” field, an “issued date” field, an “address of receipt place”, an “order receiving corporation code” and a “completed date” field. The invoice number among these items is an identification number unique to the invoice when receiving the article. Further, the order number identifies which order the article is delivered by.

The receipt result line data table is recorded with data contained in each invoice. The receipt result line data table has an “invoice number (I/V#)” field, an “invoice line number (I/V Line#)” field, an “order number (P/O#)” field, an “order data line number (P/O Line#)” field, an “issued date” field, a “figure number” field, an “article name” field, an “ordered quantity” field, a “desired delivery date” field, a “receipt result quantity” field and a “receipt date” field.

FIG. 16 shows an example of the data structure of the back order database. The back order database also includes a header data table and a line data table.

The header data table of the back order database has an “order number (P/O#)” field, an “revision number” field, a “receipt date” field, a “name of delivery destination” field, an “address of delivery destination”, a “freight terms” field, an “ordering corporation code” field and a “status” field.

Moreover, the line data table of the back order database is recorded with the line data in the received order data (FIG. 12). An order number is, however, added in order to identify each record of order data. Namely, the line data table of the back order database contains an “order number” field, a “line number (Line#)” field, an “receipt date” field, a “figure number” field, an “article name” field, a “quantity” field, a “desired delivery date” field, a “unit price” field and a “status” field. The “status” field among these fields is recorded with a present status of progress corresponding to the order concerned.

FIG. 17 shows an example of the data structure of the invoice database. The invoice database also includes a header data (I/V header data) table and a line data (I/V line data) table.

The I/V header data table has an “invoice number (I/V#)” field, an “order number (P/O#)” field, a “P/O count” field, an “invoice issued date (I/V issued date)” field, and an “address of delivery destination” field.

The I/V line data are detailed data of the article that are contained in each invoice. The I/V line data table has an “invoice number (I/V#)” field, an “invoice line number (I/V Line#)” field, an “order number (P/O#)” field, an “purchase order line number (P/O Line#)” field, a “figure number” field, an “article name” field and a “shipping quantity” field.

FIG. 18 shows an example of the data structure of the inventory database. The inventory database is recorded with an inventory quantity in each virtual corporation. Each of records stored in the inventory database consists of pieces of data entered in a “figure number” field, an “article name” field, a “place” field and a “quantity” field. With this data structure, the inventory database functions to manage the inventory quantity at every place of the article identified by each figure number.

FIG. 19 shows an example of the data structure of the in-transit database. The in-transit database is stored with data about in-transit article (that is in transit between the respective divisions) after being shipped till a completion of the receipt.

As shown in FIG. 19, each of records stored in the in-transit database consists of pieces of data entered in a “figure number” field, an “article name” field, a “region” field and “a quantity” field. The region among these items is an in-transit region (route) (ranging from the shipping place to the receiving place) of the article. Further, the “quantity” field is recorded with a quantity of the in-transit articles (identified by the figured number and the region as well).

As illustrated in FIG. 19, the quantity of the in-transit article is a difference between a quantity of the shipped articles in the shipping result database in the division (corresponding to the corporation B in FIG. 19) of the order receiving party and a quantity of the received articles in the receipt result database in the division (corresponding to the corporation A in FIG. 19) of the ordering party.

As seen in the tables illustrated downwards in FIG. 19, 90 pieces of articles specified by the invoice number I/V2 and the figure number FMW-01 were shipped from the order receiving part (the corporation B), and nevertheless the ordering party (the corporation A) does not yet receive. Accordingly, these 90 pieces of articles are recorded in the in-transit database.

<Operation and Effects>

FIG. 20 shows the internal processing flow of the ordering restoration process and the order receiving restoration process. This processing flow indicates the processes of a program executed by the unillustrated CPU of the restoration processing system 5.

A start of the ordering restoration process is triggered by the restoration processing system 5 receiving the ordering data (P/O) from the collaboration ring 4 (S11). At this time, the corporation code (the order receiving corporation code) indicating the corporation as an addressee of this item of ordering data and the corporation code (the ordering corporation code) indicating the corporation as a sender of the ordering data, are transferred to the restoration processing system 5 from the collaboration ring 4.

The restoration processing system 5 at first judges based on this ordering corporation code which corporation's database the data should be saved in (S12).

Next, the restoration processing system 5 compares the contract terms in the order data with the contract terms registered in the contract terms master table of the ordering corporation. Then, if the contract terms of the ordering corporation are different from the contract terms in the order data, the restoration processing system 5 updates the contract terms master table. Further, if the contract terms master table of the same ordering corporation does not exist, the restoration processing system 5 generates afresh records of the contract terms master table, and stores these contract terms described in the order data (S13).

Subsequently, the restoration processing system 5, based on the line data in the order data, updates the contents in the figure number master table and in the price master table. If there exists neither the figure number master table nor the prices master table of the article concerned, however, the restoration processing system 5 generates records afresh (S14).

Next, the restoration processing system 5, based on the line data in the order data, generates the records and updates the remaining order database (S15). Thereafter, the restoration processing system 5 finishes the ordering restoration process.

A start of the order receiving restoration process is triggered by the restoration processing system 5 receiving the order receipt notice (addressed to the ordering division from the order receiving division) from the collaboration ring 4. At this time, the corporation code (the order receiving corporation code) indicating the corporation as a sender of this order receipt notice and the corporation code (the ordering corporation code) indicating the corporation as an addressee of the order receipt notice, are transferred to the restoration processing system 5 from the collaboration ring 4.

In this order receiving restoration process, to begin with, the restoration processing system 5 receives the order data from the collaboration ring 4 (S21).

Next, the restoration processing system 5 judges based on the above order receiving corporation code which corporation's database the data should be saved in (S22).

Next, the restoration processing system 5 compares the contract terms in the order data with the contract terms registered in the contract terms master table of the order receiving corporation. Then, if the contract terms of the order receiving corporation are different from the contract terms in the order data, the restoration processing system 5 updates the contract terms master table. Further, if the contract terms master table of the same order receiving corporation does not exist, the restoration processing system 5 generates afresh records of the contract terms master table, and stores these contract terms described in the order data (S23).

Subsequently, the restoration processing system 5, based on the line data in the order data, updates the contents in the figure number master table and in the price master table. If there exists neither the figure number master table nor the prices master table of the article concerned, however, the restoration processing system 5 generates records afresh (S24).

Next, the restoration processing system 5, based on the line data in the order data, generates the records and updates the back order database (S25). Thereafter, the restoration processing system 5 finishes the order receiving restoration process.

FIG. 21 shows the internal processing flow of the shipping restoration process and the receipt restoration process. This processing flow in FIG. 21 also indicates the processes of a program executed by the unillustrated CPU of the restoration processing system 5.

The shipping restoration process is started by the restoration processing system 5 receiving the invoice (I/V) from the collaboration ring 4 (S31). At this time, the corporation code (the order receiving corporation code) indicating the corporation as a sender of this invoice and the corporation code (the ordering corporation code) indicating the corporation as an addressee thereof, are transferred to the restoration processing system 5 from the collaboration ring 4.

The restoration processing system 5 at first judges based on this order receiving corporation code which corporation's database the data should be saved in (S32).

Next, the restoration processing system 5 decreases an inventory quantity in the inventory database on the basis of the figure number and the shipping quantity data in the invoice (S33). Subsequently, the restoration processing system 5 increases an inventory quantity in the in-transit database on the basis of the figure number and the shipping quantity data in the invoice (S34).

Next, the restoration processing system 5 updates the figure number master table on the basis of the figure number data in the invoice database (S35). Further, the restoration processing system 5 records the contents of the invoice in the invoice database (S36).

The receipt restoration process is started by the restoration processing system 5 receiving a receipt completion notice from the computer of the ordering party.

In this process, the restoration processing system 5 at first receives the receipt acknowledgement data (the receipt completion notice) from the collaboration ring 4 (S41). At this time, the corporation code (the ordering corporation code) indicating the corporation as a sender of the receipt acknowledgement data and the corporation code (the order receiving corporation code) indicating the corporation as an addressee thereof, are transferred to the restoration processing system 5 from the collaboration ring 4.

The restoration processing system 5 at first judges based on the above ordering corporation code which corporation's database the data should be saved in (S42).

Next, the restoration processing system 5 increases an inventory quantity in the inventory database on the basis of the figure number and the shipping quantity data in the receipt acknowledgement data (S43). Subsequently, the restoration processing system 5 decreases an inventory quantity in the in-transit database on the basis of the figure number and the shipping quantity data in the receipt acknowledgement data (S44).

Next, the restoration processing system 5 updates the figure number master table on the basis of the figure number data in the receipt acknowledgement data (S45). Further, the restoration processing system 5 creates a receipt result from the receipt acknowledgement data and records its content in the receipt result database (S46).

As discussed above, the user is able to confirm the inside data such as the order issuing/receiving remaining data and so forth that should essentially be by referring to the various categories of databases on the restoration processing system 5. These items of inside data are generated based on the data occurred on the interfaces between the organizations, and represent the data that should essentially be recognized by the inside data retaining division as viewed from the outside organization.

In this case, the restoration processing system 5, for instance, when the order data are transmitted from the ordering corporation, restores the ordering process of this ordering corporation. Then, the restoration processing system 5, just when the order receipt acknowledgement with respect to the order data is sent back to the ordering corporation from the order receiving corporation, restores the order receiving process of the order receiving corporation.

Thus, the restoration processing system 5, just when the data are outputted to the outside of the organization, restores the inside procedures of this organization. Therefore, the restoration processing system 5 is capable of precisely following what the organization is making the real procedures. Namely, the restoration processing system 5 is capable of reflecting what each corporation should be.

Further the information system described above saves, each time the transaction occurs (the data are transferred and received between the organizations), these pieces of data. It is therefore feasible to restore the inside data of the organizations by reflecting the transfer and receipt of the data between the organizations in real time.

Moreover, according to the information system described above, the respective organizations are capable of sharing the data restored by the restoration processing system 5 among the corporations.

Further, the timings when, for example, the corporation A issues P/O and when the corporation B receives P/O can be grasped in the order tracking across the corporations by making use of the databases on the restoration processing system 5.

Furthermore, the in-transit status of the article that has already been shipped from the shipment originating corporation but not yet received at the shipping destination, can be managed by use of the in-transit database on the restoration processing system 5.

Still further, the user is able to utilize the functions such as the order tracking, the difference management and so on by executing the general operations with respect to the databases on the restoration processing system 5.

<Modified Example>

The embodiment discussed above has exemplified the case where the relational databases are, it is assumed, provided as the databases, and the SQL (Structured Query Language) is used as the query language for extracting the data from the database (FIGS. 11 and 13). The embodiment of the present invention is not, however, limited to the architecture and the procedures described above. For example, the database may be described in XML (eXtensible Markup Language), and an XML query language may be used as the query language.

The discussion in the embodiment discussed above has been focused on the information system in which the data are transmitted between the organizations via the collaboration rings 4, and the information transmitted are transferred to the restoration processing system 5. The embodiment of the present invention is not, however, limited to this architecture.

For instance, the collaboration ring 4 being unused, a computer including a storage unit and a communication unit may be used as a substitute for the collaboration ring 4. In this case, the data flowing between the organizations may be transferred to the restoration processing system 5 by executing a processing program on the computer.

<Readable-by-Computer Recording Medium>

The program read by the computer to execute the processes of the restoration processing system 5 in the embodiment discussed above may be recorded on a readable-by-computer recording medium. Then, the computer reads and executes the program on this recording medium, there by providing the functions of the restoration processing system 5 shown in the embodiment discussed above.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<Data Communication Signal Embodied in Carrier Wave>

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to provides the functions of the restoration processing system 5.

Herein, the communication media may be any one of cable communication mediums such as metallic cables including a coaxial cable and a twisted pair cable, optical communication cables, or wireless communication media such as satellite communications, ground wave wireless communications, etc. Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be anyone of a modulated broadband signal and an unmodulated base band signal (corresponding to a case of setting a DC signal having a voltage of 0 as a carrier wave).

What is claimed is:

1. A readable-by-computer recording medium recorded with a program read by a computer to manage data generated by a plurality of organizations on the basis of communication data transferred and received between said organizations, which executes:
inputting the communication data sent from a first organization to a second organization;
simulating a first intra-organization procedure executed in said first organization when sending the communication data; and
recording first data generated by the first intra-organization procedure.

2. A readable-by-computer recording medium recorded with a program read by a computer to manage data generated by a plurality of organizations on the basis of communication data transferred and received between said organizations, which executes:
inputting the communication data sent from a first organization to a second organization;
detecting reply data to the communication data sent to said first organization from said second organization;
simulating an intra-organization procedure executed in said second organization when sending the communication data; and
recording data generated by the intra-organization procedure.

3. A readable-by-computer recording medium recorded with a program according to claim 1, wherein said computer further executes:
detecting reply data to the communication data sent to said first organization from said second organization;
simulating a second intra-organization procedure executed in said second organization when sending the communication data; and
recording second data generated by the second intra-organization procedure.

4. A readable-by-computer recording medium recorded with a program according to claim 3, wherein said computer further executes comparing the first data with the second data, and detects difference data between the organizations.

5. A readable-by-computer recording medium recorded with a program according to claim 3, wherein said computer further executes coupling the first data and the second data together, and tracks the procedures executed between the organizations.

6. An organization activity management method of managing data generated by a plurality of organizations on the basis of communication data transferred and received between said organizations, said method comprising:
inputting the communication data sent from a first organization to a second organization;
simulating a first intra-organization procedure executed in said first organization when sending the communication data; and
recording first data generated by the first intra-organization procedure.

7. An organization activity management method of managing data generated by a plurality of organizations on the basis of communication data transferred and received between said organizations, said method comprising:
inputting the communication data sent from a first organization to a second organization;
detecting reply data to the communication data sent to said first organization from said second organization;
simulating an intra-organization procedure executed in said second organization when sending the communication data; and
recording data generated by the intra-organization procedure.

8. An organization activity management method according to claim 6, further comprising:
detecting reply data to the communication data sent to said first organization from said second organization;
simulating a second intra-organization procedure executed in said second organization when sending the communication data; and
recording second data generated by the second intra-organization procedure.

9. An organization activity management method according to claim 8, further comprising comparing the first data with the second data,
wherein difference data between the organizations are detected.

10. An organization activity management method according to claim 8, further comprising coupling the first data and the second data together,
wherein the procedures executed between the organizations are tracked.

11. An information processing system managing data generated by a plurality of organizations on the basis of communication data transferred and received between said organizations, said system comprising:
a module inputting the communication data sent from a first organization to a second organization;
a module simulating a first intra-organization procedure executed in said first organization when sending the communication data; and
a module recording first data generated by the first intra-organization procedure.

12. An information processing system managing data generated by a plurality of organizations on the basis of communication data transferred and received between said organizations, said system comprising:
a module inputting the communication data sent from a first organization to a second organization;
a module detecting reply data to the communication data sent to said first organization from said second organization;
a module simulating an intra-organization procedure executed in said second organization when sending the communication data; and
a module recording data generated by the intra-organization procedure.

13. An information processing system according to claim 11, further comprising:
a module detecting reply data to the communication data sent to said first organization from said second organization;
a module simulating a second intra-organization procedure executed in said second organization when sending the communication data; and
a module recording second data generated by the second intra-organization procedure.

14. An information processing system according to claim 13, further comprising a module comparing the first data with the second data,
wherein difference data between the organizations are detected.

15. An information processing system according to claim 13, further comprising a module coupling the first data and the second data together,
wherein the procedures executed between the organizations are tracked.
